(19) United States
(12) Patent Application Publication
(10) Pub. No.: US 2011/0308990 A1
(43) Pub. Date: Dec. 22, 2011

(54) DEPLOYABLE COLLAPSIBLE SIGN ASSEMBLY

(76) Inventor: Joel D. Pounders, Kentwood, MI (US)

(21) Appl. No.: 13/165,493

(22) Filed: Jun. 21, 2011

Related U.S. Application Data
(60) Provisional application No. 61/397,991, filed on Jun. 21, 2010.

(51) Int. Cl. B65D 85/00; F21L 13/00; F16M 11/28

(52) U.S. Cl. 206/525; 248/156; 362/183

(57) ABSTRACT

A deployable collapsible sign assembly having a stake capable of being disposed within the ground. The stake having an upper plate. A first vertical member slidably disposed over the stake, and a second vertical member slidably disposed within the first vertical member. The second vertical member having a bottom capable of contacting the upper plate. The second vertical member having a second vertical member aperture that is higher on one side then the other to create an offset to hold a horizontal member, to hold a sign therebelow.

### RELATED APPLICATION

This application claims priority from provisional patent application filed on 21 Jun. 2011, bearing application No. 61/397,991.

### GOVERNMENT RIGHTS

This invention was not made with Government support. The Government does not have any rights in this invention.

### BACKGROUND OF THE INVENTION

The transport and deployment of temporary signs is used in many different professions, such as realtors, day care centers, or temporary home workers. Realtors for example place signs in yards to inform people that a particular parcel may be for sale, or that an open house event may be taking place.

Small signs, such as those made of ¼ inch metal poles are currently used by some. A larger sign may draw more attention, however the larger sign may be impossible or inconvenient to transport and/or set up.

What is needed is a large attractive sign, which is lightweight, and can be collapsible and deployable.

### SUMMARY OF THE INVENTION

One aspect of the present invention is a deployable collapsible sign assembly 10, comprising: a stake 150 capable of being disposed within the ground, said stake having an upper plate 270; a first vertical member 20 slidably disposed over said stake 150, and a second vertical member 30 slidably disposed within said first vertical member 20, said second vertical member 30 having a bottom 350 capable of contacting said upper plate 270, said second vertical member 30 having a second vertical member aperture 50 that is higher on one side then the other to create an offset 280.

Another aspect is a collapsible sign post assembly 10, comprising: a first vertical member 20 having an inner sleeve 190; a second vertical member 30 slidably disposed within said first vertical member 20, said second vertical member 30 capable of sliding within said first vertical member for storage, said second vertical member 30 having a bottom 350 that is capable of contacting an upper plate 270 on a stake 150, said first vertical member 20 extending downwardly to a first vertical member termination 380, whereby when said first vertical member 20 is positioned downwardly over said stake 150, said first vertical member termination 380 can be descended to be adjacent to the ground; said second vertical member 30 having a second vertical member aperture 50; said second vertical member aperture 50 having a first lower edge 290 and a first higher edge 400 disposed upwardly from a second lower edge 410 and second higher edge 300 to create an offset 280, whereby when a horizontal member 40 is removably disposed within said second vertical member aperture 50 any downward force against said first lower edge 290 secures the horizontal member 40 in place.

These and other features, aspects and advantages of the present invention will become better understood with reference to the following drawings, description and claims.

### DETAILED DESCRIPTION OF THE PRESENT INVENTION

10 collapsible sign post assembly
20 first vertical member
30 second vertical member
40 horizontal member
50 second vertical member aperture
60 container
70 strap-sign connection means
80 strap
90 sign
100 eye screw/U-clip
110 hook/C-clip
120 securement means
130 right portion
140 left portion
150 ground support means
160 first internal support
170 second internal support
180 foot drive member
190 first vertical member internal sleeve
200 horizontal member aperture
210 U-clip
220 C-clip
230 clevis pin
240 stabilizer plate
250 lower plate
260 middle plate
270 upper plate
280 offset
290 first lower edge
300 second higher edge
310 decorative lower cover
320 solar light
330 point
340 insecticidal foam
350 bottom
360 slider
370 fastener
380 first vertical member termination
400 first higher edge
410 second lower edge

Certain terminology will be used in the following description for convenience and reference only, and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the system and designated parts. Said terminology will include the words specifically mentioned, derivatives, and similar words. Also, “connected to,” “secured to,” or similar language includes the definitions “indirectly connected to,” “directly connected to,” “indirectly secured to,” and “directly secured to.”

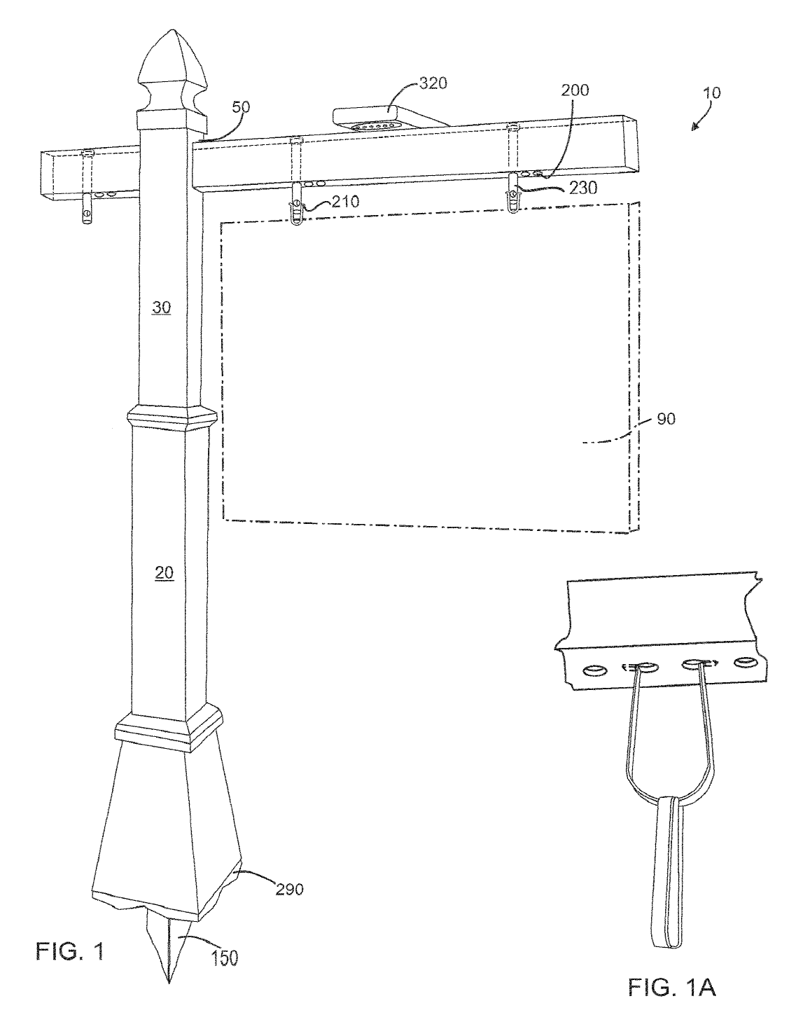

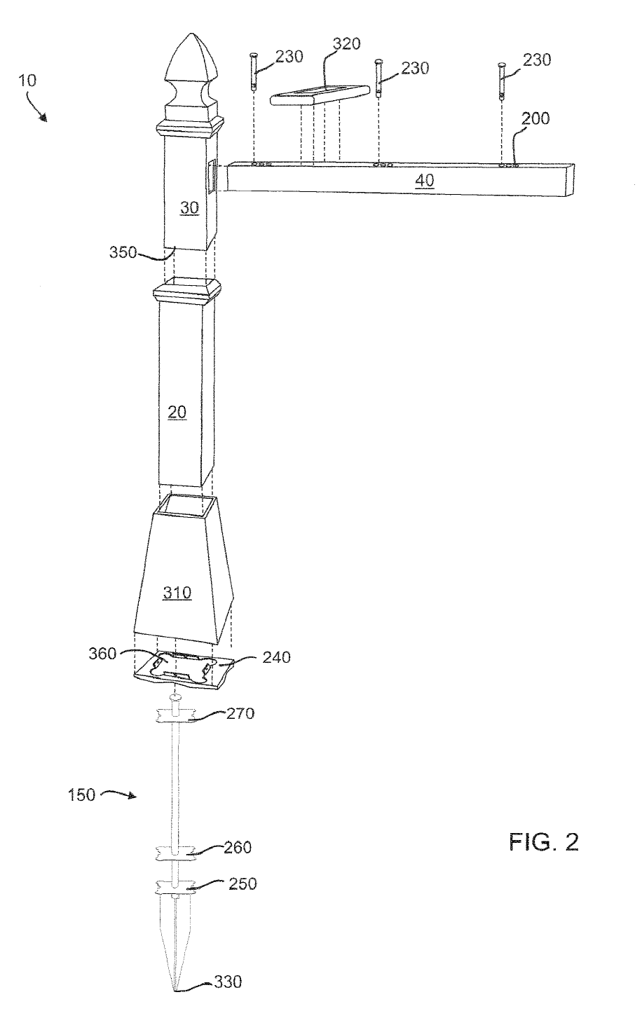

FIG. 1 illustrates a collapsible sign post assembly 10. The collapsible sign post assembly 10 may be fixed in the ground by first inserting into the ground a ground support means or stake 150, as illustrated more fully in FIG. 2. The stake 150 may have a lower plate 250, a middle plate 260, and upper plate 270. The stake 150 may terminate in a point 330 on one end. The lower plate 250 may provide for a limit on the depth of the stake 150, and when in the ground would be substantially flush with the ground. The lower plate 250 may be between the point 330 and a middle plate 260. The middle plate 260 may be disposed upwardly from the lower plate 250. The upper plate 270 may be disposed upwardly from the middle plate 260. The middle plate 260 and upper plate 270 may fit just inside the inside an internal sleeve 190 of the first vertical member 20, so that the first vertical member 20 fits and slides over the middle plate 260 and the upper plate 270, yet be nearly contacting the substantial portion of the perimeter of the middle plate 260 and the upper plate 270, so that the first vertical member 20 has minimal lateral movement to create a stable fit. The first vertical member 20 may extend downwardly to a first vertical member termination 380.

The second vertical member 30 may slide within the first vertical member 20. Whereby when the first vertical member 20 is slid over the stake 150, the upper plate 270 may contact the lower edge of the second vertical member 30 to cause the second vertical member 30 to telescope upwardly with relation to the first vertical member 20.

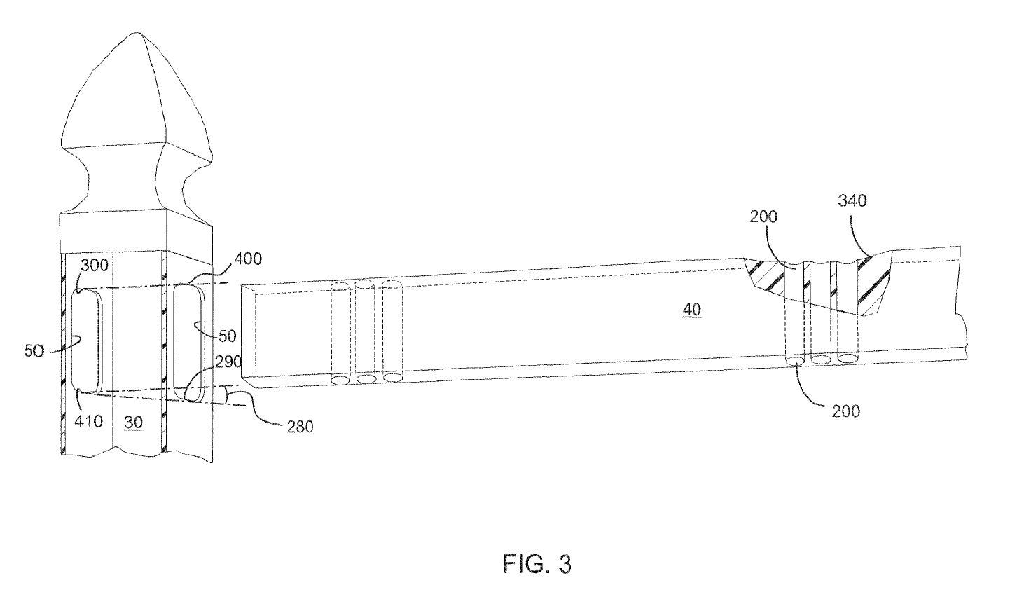

The second vertical member 30 may have a second vertical member aperture 50 to slidably receive and hold a horizontal member 40. As seen in FIG. 3, the second vertical member aperture 50 may be lower on one side then the other to create an offset 280. The horizontal member 40 may then be slid within the second vertical member aperture 50 at a slight angle so that the heavier portion of the horizontal member is extending outwardly from the higher portion of the second vertical member aperture 50. Therefore as the heavier portion of the horizontal member is forced downwardly by gravity against the lower edge 290 of the higher portion of the second vertical member aperture 50, the horizontal member is forced against the higher edge 300 of the lower portion of the second vertical member aperture 50 to create a tight fit between the horizontal member 40 and the second vertical member aperture 50. In other words, the second vertical member aperture 50 may have a first lower edge 290 and a first higher edge 400 disposed upwardly from a second lower edge 410 and a second higher edge 300 to create an offset 280.

In one embodiment the aperture 50 may be slighter higher on the right side of the second vertical member 30, than the left side aperture 50. When the right aperture 50 is higher than the left aperture 50, and the horizontal member 40 is disposed through both the right aperture 50 and left aperture 50, and when the horizontal member 40 extends rightwardly with the sign 90 hanging from the horizontal member 40, then the weight on the horizontal member 40 causes a clockwise force on the right and left apertures 50, thus causing the bottom of the right aperture 50, and top of the left aperture 50 to receive most of the force. This acts as a lock, keeping the horizontal member 40 in place, and preventing it from being pulled out. To remove the horizontal member 40, the right side would have to be raised and then pulled at a slight angle.

A clevis pin 230 may be removably yet securely positioned within a horizontal member aperture 200. A clip, such as a U-clip can be removably positioned through a hole at the lower end of the clevis pin 200. The U-clip 210 may then be connected to a sign 90 or another type of clip that may connect to the sign 90.

FIG. 1 also illustrates a solar light 320 secured to the horizontal member 40 to receive solar power from its top side, to power lights on the bottom side to illuminate a sign hanging below the solar light 320.

FIG. 1A illustrates the use of a U-clip that may be removably disposed within the horizontal member aperture 40.

FIG. 2 illustrates an embodiment of the collapsible sign post assembly in a “disassembled” state. The second vertical member 30 slides within the first vertical member 20. The stake 150 slides within the first vertical member 20. The bottom 350 of the second vertical member 30 contacts the upper plate 270. This way when the stake 150 is in the ground, the second vertical member 30 can extend upwardly from the first vertical member 20. A stabilizer plate 270 may be securely connected to the lower end of first vertical member 20. One means of connected the stabilizer plate 270 to the first vertical member 20 may be using four fasteners such bolts or screws. A decorative cover 310 may be slidably mounted on the first vertical member 20, and may rest on the stabilizer plate 270 or ground. The stake 150 may be able to be slidably disposed through the stabilizer plate 270 as the stabilizer plate 270 may have an opening 360 large enough for the stake 150 to pass through.

The second vertical member 30 may be telescopically disposed within the first vertical member 20, and the second vertical member 30 be able to slide within the first vertical member 20. For example, when lifting the first vertical member 20 upwardly from the ground or stake 150, then the second vertical member 30 may remain fixed with respect to the stake 150, but may telescopically be disposed or lowered with respect to the first vertical member 20.

The second vertical member 30 may be able to be adjustably secured in place relative to the first vertical member 20. For example, the second vertical member 30 may telescope out from the first vertical member 20, and be secured in place at different heights, depending on the desired height. The second vertical member 30 may be secured in place relative to the first vertical member via the height and position of the upper plate 270.

FIG. 2 also illustrates an embodiment as to how the sign may be disassembled. The horizontal member 40 may be removed from the aperture 50, and the clevis pins 230 removed from the horizontal member apertures 40.

FIG. 3 illustrates not only the offset 280 as referenced above, but also an embodiment wherein an insecticidal foam 340 may be disposed within the horizontal member 40 to repel bees, wasps, and other insects that may otherwise cause to live within any openings or spaces within the sign post assembly 10. The horizontal member aperture 40 may be disposed through the insecticidal foam or material.

The second vertical member 30 may be able to be adjustably secured in place relative to the first vertical member 20. For example, the second vertical member 30 may telescope out from the first vertical member 20, and be secured in place at different heights, depending on the desired height of the upper plate 270.

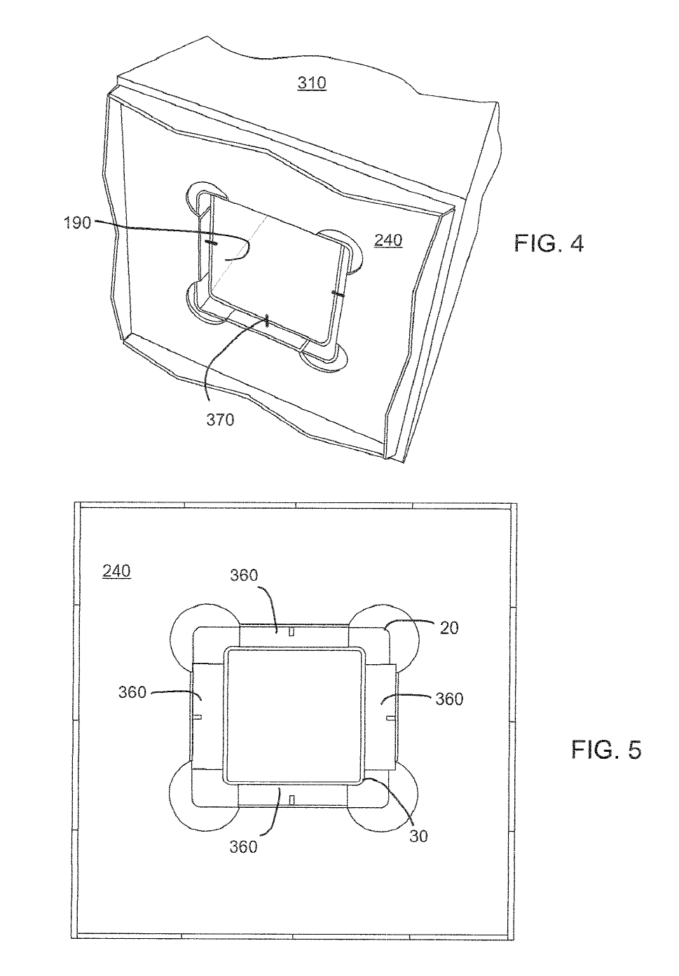

FIG. 4 illustrates one embodiment as to how the stabilizer plate 240 may be secured to the first vertical member 20 via a fastener 370. The decorative housing 310 may be sized to slide over at least a portion of the stabilizer plate 240.

FIG. 5 illustrates one embodiment of the present invention 10 whereby a slider 360 may be securely connected to the outside wall of the second vertical member 30 to slidably engage with the inside sleeve 190. In the case of a square shaped first vertical member 20, and square second vertical member 30 four sliders 360 may be used. The vermiculate sliders 360 may be secured near the bottom of the second vertical member 30. Or, there may be some sliders 360 near the bottom of the second vertical member 30, and some near the top of the second vertical member 30. In one embodiment of the present invention, the slider 360 may be made of vermiculite or a vermiculite-like material.

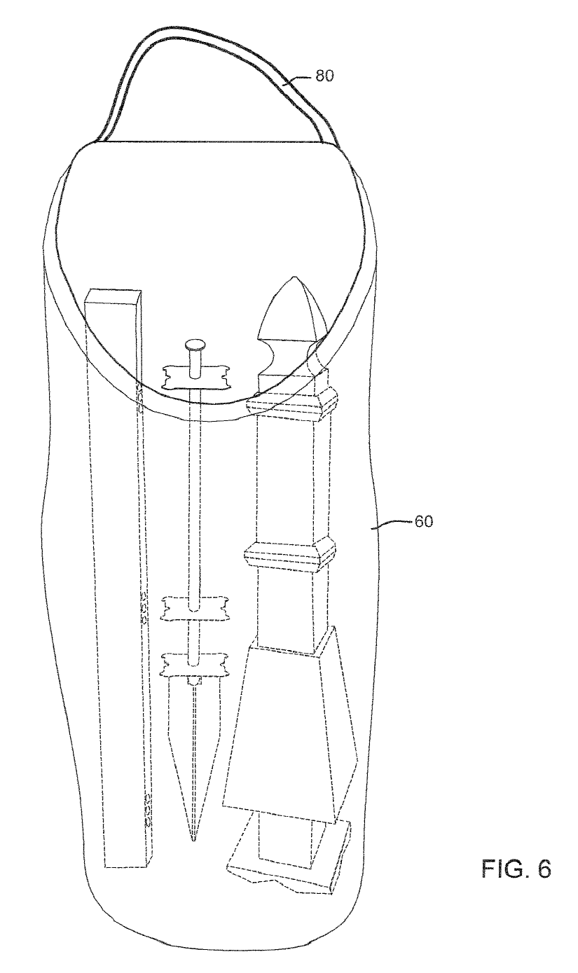

As illustrated in FIG. 6, the components of the collapsible sign post assembly 10 may be stowed within a container 60. For example, the horizontal member 40 may be stowed within the hollow second vertical member 30, as illustrated in FIG. 4. And the ground support means 150 may be capable of being stowed within the first vertical member 20. The container 60, which can receive the collapsible sign post assembly 10. The container 60 may have a strap 80 so that the collapsible sign post assembly can be easily transported within small motor vehicles, and deployed at desired locations. In one embodiment the container 60 may have two compartments, one for the stake 150, the other for the sign assembly 20.

The second vertical member 30 may be slidably disposed within said first vertical member 20, so that it can telescope inward, for storage and transport, or upwardly when in use.

In one embodiment the second vertical member 30 may telescope upwardly with respect to the first vertical member 20 until it is stopped or prevented from further upward displacement by a means to stop upward displacement (not illustrated). The means to stop upward displacement of the second vertical member 30 with respect to the first vertical member 20 may be a collar on the second vertical member 30 that contacts another collar secured to the inside of the first vertical member.

In one embodiment the collapsible sign post assembly 10 may be made of a lightweight plastic, PVC, or composite material that has properties of lightweight and rigidity.

It should be understood, of course, that the foregoing relates to exemplary embodiments of the invention and that modifications may be made without departing from the spirit and scope of the invention as set forth in the following claims.

I claim:

1. A deployable collapsible sign assembly (10), comprising:
a stake (150) capable of being disposed within the ground, said stake having an upper plate (270);
a first vertical member (20) slidably disposed over said stake (150), and
a second vertical member (30) slidably disposed within said first vertical member (20), said second vertical member (30) having a bottom (350) capable of contacting said upper plate (270), said second vertical member (30) having a second vertical member aperture (50) that is higher on one side then the other to create an offset (280).

2. The apparatus of claim 1, further comprising:
a horizontal member (40) capable of being removably disposed through said second vertical member aperture (50).

3. The apparatus of claim 1, further comprising:
a clevis pin (230) removably disposed through horizontal member aperture.

4. The apparatus of claim 1, wherein said stake (150) has a middle plate (200) disposed downwardly from said upper plate (270).

5. The apparatus of claim 1, wherein said stake (150) has a lower plate (250) disposed downwardly from said middle plate (260).

6. The apparatus of claim 1, wherein said stake (150) extends downwardly from said lower plate (250) to a point (330).

7. The apparatus of claim 1, further comprising:
a slider (360) fixedly disposed near the bottom of said second vertical member (30) that is capable of being in sliding contact with an inner sleeve (190) of said first vertical member (20).

8. The apparatus of claim 1, wherein said slider (360) is made of vermiculite.

9. The apparatus of claim 1, wherein a stabilizer plate (240) is secured to the lower end of the first vertical member (20).

10. The apparatus of claim 2, wherein said horizontal member (40) has an insecticide substance within said horizontal member (40).

11. The apparatus of claim 2, further comprising:
a solar light (320) secured to said horizontal member (40) to illuminate a sign below said solar light.

12. The apparatus of claim 1, further comprising:
a container (60) capable of receiving, housing, and transporting the components of the collapsible sign post assembly, said container (60) having a strap (80) to carry said container (60).

13. A collapsible sign post assembly (10), comprising:
a first vertical member (20) having an inner sleeve (190);
a second vertical member (30) slidably disposed within said first vertical member (20), said second vertical member (30) capable of sliding within said first vertical member for storage, said second vertical member (30) having a bottom (350) that is capable of contacting an upper plate (270) on a stake (150), said first vertical member (20) extending downwardly to a first vertical member termination (380), whereby when said first vertical member (20) is positioned downwardly over said stake (150), said first vertical member termination (380) can be descended to be adjacent to the ground; said second vertical member (30) having a second vertical member aperture (50);
said second vertical member aperture (50) having a first lower edge (290) and a first higher edge (400) disposed upwardly from a second lower edge (410) and second higher edge (300) to create an offset (280), whereby when a horizontal member (40) is removably disposed within said second vertical member aperture (50) any downward force against said first lower edge (290) secures the horizontal member (40) in place.

14. The apparatus of claim 13, further comprising:
a clevis pin (230) removably disposed through horizontal member aperture.

15. The apparatus of claim 13, wherein said stake (150) extends downwardly from said lower plate (250) to a point (330).

16. The apparatus of claim 13, further comprising:
a slider (360) fixedly disposed near the bottom of said second vertical member (30) that is capable of being in sliding contact with an inner sleeve (190) of said first vertical member (20), said slider (360) made of a vermiculite-like material.

17. The apparatus of claim 13, wherein a stabilizer plate (240) is secured to the lower end of the first vertical member (20).

18. The apparatus of claim 13, wherein said horizontal member (40) has an insecticide substance within said horizontal member (40).

19. The apparatus of claim 13, further comprising:
a solar light (320) secured to said horizontal member (40) to illuminate a sign below said solar light.

20. The apparatus of claim 13, further comprising:
a container (60) capable of receiving, housing, and transporting the components of the collapsible sign post assembly, said container (60) having a strap (80) to carry said container (60).
